(19) United States
(12) Patent Application Publication
(10) Pub. No.: US 2025/0249717 A1
(43) Pub. Date: Aug. 7, 2025

(54) ZERO-TURN-RADIUS RIDING MOWER FRONT SUSPENSION SYSTEM

(71) Applicant: Bad Boy Mowers, LLC, Batesville, AR (US)

(72) Inventors: Zachary Crowl, Batesville, AR (US); Kenny Cox, Batesville, AR (US)

(21) Appl. No.: 18/588,675

(22) Filed: Feb. 27, 2024

Related U.S. Application Data
(60) Provisional application No. 63/586,896, filed on Sep. 29, 2023.

(51) Int. Cl. B60G 3/06; A01D 34/66; A01D 67/00; A01D 101/00; B60B 33/00; B60G 7/02; B62D 11/04

(52) U.S. Cl. CPC B60G 3/06; A01D 67/00; B60G 7/02; B62D 11/04; A01D 34/66; A01D 2101/00; B60B 33/0068; B60G 2200/142; B60G 2204/143; B60G 2300/084

(57) ABSTRACT

A mower system including a front wheel suspension system to provide regulated movement of a front wheel relative to a frame of the mower system, including a pivoting wheel assembly that includes a wheel arm pivotably coupled to a frame member by way of a pivot and to pivot about a pivot axis defined by the pivot, the wheel coupled to the wheel arm, and a resilient member assembly disposed between the wheel arm and the frame member, the resilient member assembly to be compressed between the wheel arm and the frame member to dampen pivoting of the wheel arm and the front wheel about the pivot axis.

### RELATED APPLICATIONS

This application claims benefit of and priority to U.S. Patent Application No. 63/586,896 filed Sep. 29, 2023 and titled “ZERO-TURN-RADIUS RIDING MOWER FRONT SUSPENSION”, the entirety of which is hereby incorporated by reference.

### FIELD

Embodiments relate generally to mowing devices and more particularly to riding mower suspension systems.

### BACKGROUND

A lawn mower (or “mower”) is a device that is used to cut (or “mow”) grassy areas. A mower typically utilizes one or more rotating blades that cut grass as the mower travels across the ground. A mower often takes the form of a walk-behind mower or a riding mower (or “ride-on” mower). A walk-behind mower is typically operated by an operator that walks behind and guides the mower. Some walk-behind mowers rely on the operator pushing the mower for propulsion (often referred to as “push” mowers). Some walk-behind mowers have a drive system (or a “propulsion” system) that assists in propelling the mower (often referred to as “self-propelled” walk-behind mowers). A riding mower is typically operated by an operator that rides on the mower as it travels across the ground. A riding mower normally includes an operator support, such as a seat or platform, and a drive system that propels the mower.

A zero-turn-radius (ZTR) riding mower is a type of riding mower. A ZTR riding mower typically includes right and left control handles (or “control arms” or “drive arms” or “control levers” or “steering levers”) that an operator can push and pull to cause forward or backward rotation of right and left drive wheels, independent of one another. This can enable the mower to make sharp turns with ease, even spinning the entire mower in place—hence the label “zero-turn-radius.” A ZTR riding mower is often desirable for its agility, speed, and wide mowing coverage. A ZTR mower typically employs drive units, such as hydrostatic (or “hydraulic”) transaxles, that selectively rotate drive wheels forward or backward in response to pushing or pulling of the control handles. A ZTR mower normally employs non-driven caster-style front wheels that support the front end of the mower. The caster-style front wheels are generally free to swivel about a vertical axis, which enables the front end of the mower to turn freely in response to selective driving of the rear wheels. ZTR mowers often take the form of sit-on ZTR mowers or stand-on ZTR mowers. A sit-on ZTR mower typically includes a seat and is designed to be operated with the operator seated in the seat. A stand-on ZTR mower typically includes a platform and is designed to be operated with the operator standing on the platform. In some instances, a ZTR mower, such as a stand-on ZTR mower with the platform removed or folded-up, can be operated with the operator walking behind the mower.

### SUMMARY

Although zero-turn-radius (ZTR) riding mowers can provide advantages over other types of mowers, they can have shortcomings. For example, like other types of riding mowers, ZTR riding mowers may be operated over rough terrain (e.g., including bumps, holes, or debris) which can cause bouncing and jarring of the mower and the operator. This can be uncomfortable for the operator and can negatively impact the performance of the mower. For example, the bouncing and jarring of the mower may cause the deck and cutting blades to move relative to the ground, with at least some vertical component, while mowing. This can result in bouncing and jarring of the operator and uneven cutting of the grass.

Provided in some embodiments is a mower front wheel suspension system. For example, in some embodiments, a mower system includes a front suspension system that includes a member having a reaction surface, a front pivoting wheel assembly having a supporting surface, the front pivoting wheel assembly pivotably coupled to the member, and a resilient member assembly disposed between the reaction surface and the supporting surface.

Provided in some embodiments is a ZTR riding mower system, including: a right front caster wheel; a left front caster wheel; a right rear drive wheel adapted to be selectively driven into rotation by a right drive unit; a left rear drive wheel adapted to be selectively driven into rotation by a left drive unit; a frame system including: a frame weldment; and a front wheel suspension system including: a right front wheel suspension system adapted to provide for regulated movement of the right front caster wheel relative to the frame weldment, the right front wheel suspension system including: a right pivoting wheel assembly including: a right wheel arm pivotably coupled to a crossmember of the frame weldment by way of a right pivot and the right wheel arm adapted to pivot about a right pivot axis defined by the right pivot, the right front caster wheel coupled to the right wheel arm; and a right resilient member assembly disposed between the right wheel arm and the crossmember, the right resilient member assembly adapted to be compressed between the right wheel arm and the crossmember to dampen pivoting of the right wheel arm and the right front caster wheel about the right pivot axis; and a left pivoting wheel assembly including: a left wheel arm pivotably coupled to the crossmember of the frame weldment by way of a left pivot and the left wheel arm adapted to pivot about a left pivot axis defined by the left pivot, the left front caster wheel coupled to the left wheel arm; and a left resilient member assembly disposed between the left wheel arm and the crossmember, the left resilient member assembly adapted to be compressed between the left wheel arm and the crossmember to dampen pivoting of the left wheel arm and the left front caster wheel about the left pivot axis.

In some embodiments, the right resilient member assembly is adapted to be compressed to dampen upward movement of the right wheel arm and the right front caster wheel relative to the crossmember, and the left resilient member assembly is adapted to be compressed to dampen upward movement of the left wheel arm and the left front caster wheel relative to the crossmember. In certain embodiments, the right wheel arm includes a retaining plate including a planar surface, a right end of the crossmember includes a planar surface, and the right resilient member assembly is adapted to be compressed between the planar surface of the right retaining plate and the planar surface of the right end of the crossmember to dampen the pivoting of the right wheel arm and the right front caster wheel about the right pivot axis, and the left wheel arm includes a left retaining plate including a planar surface, a left end of the crossmember includes a planar surface, and the left resilient member assembly is adapted to be compressed between the planar surface of the left retaining plate and the planar surface of the left end of the crossmember to dampen the pivoting of the right wheel arm and the right front caster wheel about the right pivot axis. In some embodiments, the right resilient member assembly includes a right resilient member adapted to be disposed proximate a surface of the right wheel arm and a right retaining member adapted to be disposed adjacent the right resilient member and proximate a right surface of the crossmember, and the left resilient member assembly includes a left resilient member adapted to be disposed proximate a surface of the left wheel arm and a left retaining member adapted to be disposed adjacent the left resilient member and proximate a left surface of the crossmember. In certain embodiments, the right front caster wheel is adapted to swivel about a right caster axis and the right pivot axis is oriented transverse to the right caster axis, and the left front caster wheel is adapted to swivel about a left caster axis and the left pivot axis is oriented transverse to the left caster axis.

Provided in some embodiments is a mower system, including: a right front caster wheel; a left front caster wheel; a right rear drive wheel adapted to be driven into rotation; a left rear drive wheel adapted to be driven into rotation; a frame system including: a frame weldment; and a front wheel suspension system including: a right front wheel suspension system adapted to provide for regulated movement of the right front caster wheel relative to the frame weldment, the right front wheel suspension system including: a right pivoting wheel assembly including: a right wheel arm adapted to be pivotably coupled to a crossmember of the frame weldment by way of a right pivot and the right wheel arm adapted to pivot about a right pivot axis defined by the right pivot, the right front caster wheel adapted to be coupled to the right wheel arm; and a right resilient member assembly adapted to be disposed between the right wheel arm and the crossmember, the right resilient member assembly adapted to be compressed between the right wheel arm and the crossmember to dampen pivoting of the right wheel arm and the right front caster wheel about the right pivot axis; and a left pivoting wheel assembly including: a left wheel arm adapted to be pivotably coupled to the crossmember of the frame weldment by way of a left pivot and the left wheel arm adapted to pivot about a left pivot axis defined by the left pivot, the left front caster wheel adapted to be coupled to the left wheel arm; and a left resilient member assembly adapted to be disposed between the left wheel arm and the crossmember, the left resilient member assembly adapted to be compressed between the left wheel arm and the crossmember to dampen pivoting of the left wheel arm and the left front caster wheel about the left pivot axis.

In some embodiments, the right resilient member assembly is adapted to be compressed to dampen the pivoting of the right wheel arm and the right front caster wheel about the right pivot axis, and the left resilient member assembly is adapted to be compressed to dampen the pivoting of the left wheel arm and the left front caster wheel about the left pivot axis. In certain embodiments, the right wheel arm includes a planar surface, a right end of the crossmember includes a planar surface, and the right resilient member assembly is adapted to be compressed between the planar surface of the right wheel arm and the planar surface of the right end of the crossmember to dampen the pivoting of the right wheel arm and the right front caster wheel about the right pivot axis, and the left wheel arm includes a planar surface, a left end of the crossmember includes a planar surface, and the left resilient member assembly is adapted to be compressed between the planar surface of the left wheel arm and the planar surface of the left end of the crossmember to dampen the pivoting of the left wheel arm and the left front caster wheel about the left pivot axis. In some embodiments, the right resilient member assembly is adapted to be compressed to dampen upward movement of the right wheel arm and the right front caster wheel relative to the crossmember, and the left resilient member assembly is adapted to be compressed to dampen upward movement of the left wheel arm and the left front caster wheel relative to the crossmember. In certain embodiments, the right resilient member assembly includes a right resilient member adapted to be disposed proximate a surface of the right wheel arm and a right retaining member adapted to be disposed adjacent the right resilient member and proximate a right surface of the crossmember, and the left resilient member assembly includes a left resilient member adapted to be disposed proximate a surface of the left wheel arm and a left retaining member adapted to be disposed adjacent the left resilient member and proximate a left surface of the crossmember. In some embodiments, the right front caster wheel is adapted to swivel about a right caster axis and the right pivot axis is adapted to be oriented transverse to the right caster axis, and the left front caster wheel is adapted to swivel about a left caster axis and the left pivot axis is adapted to be oriented transverse to the left caster axis. In certain embodiments, where the mower system includes a ZTR riding mower system.

Provided in some embodiments, is mower system including: a front wheel suspension system adapted to provide for regulated movement of a front caster wheel relative to a frame weldment of the mower system, the front wheel suspension system including: a pivoting wheel assembly including: a wheel arm adapted to be pivotably coupled to a crossmember of the frame weldment by way of a pivot and the wheel arm adapted to pivot about a pivot axis defined by the pivot, the front caster wheel adapted to be coupled to the wheel arm; and a resilient member assembly adapted to be disposed between the wheel arm and the crossmember, the resilient member assembly adapted to be compressed between the wheel arm and the crossmember to dampen pivoting of the wheel arm and the front caster wheel about the pivot axis.

In some embodiments, the resilient member assembly is adapted to be compressed to dampen the pivoting of the wheel arm and the front caster wheel about the pivot axis. In certain embodiments, the wheel arm includes a planar surface, an end of the crossmember includes a planar surface, and the resilient member assembly is adapted to be compressed between the planar surface of the wheel arm and the planar surface of the end of the crossmember to dampen the pivoting of the wheel arm and the front caster wheel about the pivot axis. In some embodiments, the resilient member assembly is adapted to be compressed to dampen upward movement of the wheel arm and the front caster wheel relative to the crossmember. In certain embodiments, the resilient member assembly includes a resilient member and a retaining member adapted to be disposed adjacent the resilient member, and the resilient member is adapted to be disposed proximate a surface of the wheel arm and the retaining member is adapted to be disposed proximate a surface of the crossmember. In some embodiments, the front caster wheel is adapted to swivel about a caster axis and the pivot axis is adapted to be oriented transverse to the caster axis. In certain embodiments, the mower system includes a ZTR riding mower system.

### BRIEF DESCRIPTION OF THE DRAWINGS

FIGS. 1A and 1B illustrate a mower system having a front suspension system in accordance with one or more embodiments.

FIGS. 2A-2E illustrate various views of the front suspension system in accordance with one or more embodiments.

FIG. 3 illustrates an isometric exploded view of a portion of the front suspension system in accordance with one or more embodiments.

FIG. 4 illustrates a top view of the front suspension system in accordance with one or more embodiments.

FIGS. 5A-6B illustrate sectioned and detailed views of the front suspension system in accordance with one or more embodiments.

FIGS. 7A-7D illustrate various isometric views of the front suspension system in accordance with one or more embodiments.

FIGS. 8A and 8B illustrate assembled and exploded views of a resilient member in accordance with one or more embodiments.

While this disclosure is susceptible to various modifications and alternative forms, specific embodiments are shown by way of example in the drawings and will be described in detail. The drawings may not be to scale. It should be understood that the drawings and the detailed descriptions are not intended to limit the disclosure to the particular form disclosed, but are intended to disclose modifications, equivalents, and alternatives falling within the spirit and scope of the present disclosure as defined by the claims.

### DETAILED DESCRIPTION

Provided in some embodiments is a mower front wheel suspension system. For example, in some embodiments, a mower system includes a front suspension system that includes a member having a reaction surface, a front pivoting wheel assembly having a supporting surface, the front pivoting wheel assembly pivotably coupled to the member, and a resilient member assembly disposed between the reaction surface and the supporting surface.

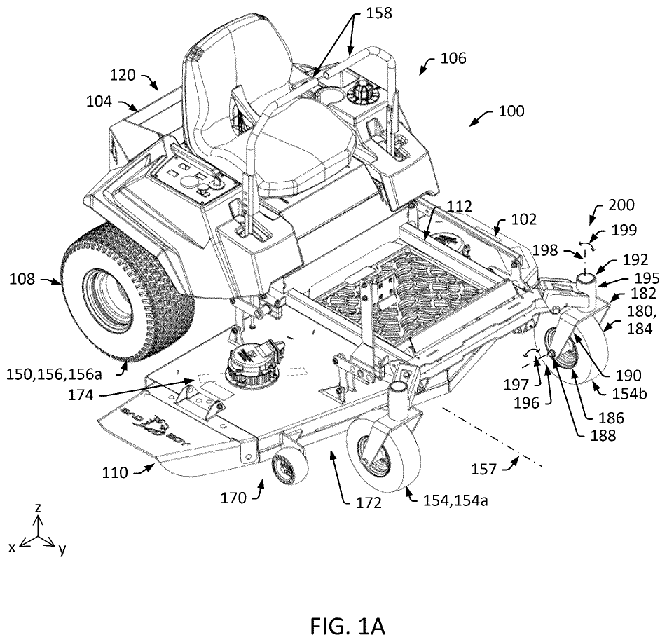

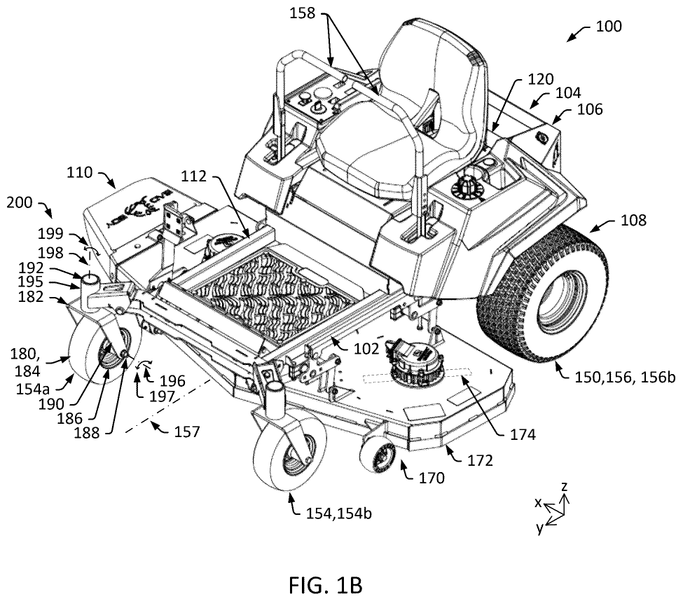

FIGS. 1A and 1B are diagrams that illustrate a sit-on ZTR riding mower (or “mower”) 100 in accordance with one or more embodiments. In some embodiments, the mower 100 includes a frame system (or “frame”) 102, a power system 104, a control system 106, a drive system 108, a cutting system 110, and a front wheel suspension system (or “suspension system”) 200.

Referring to FIGS. 1A and 1B, in some embodiments, the frame system 102 is a rigid structure that supports components of the mower 100. For example, the frame 102 may include a rigid structure formed of metal members that are rigidly fastened to one another such that they do not move relative to one another. In some embodiments, the frame 102 includes a frame weldment 112. The frame weldment 112 may include a rigid metal structure formed of multiple members that are welded, or similarly fastened, together. Other components of the mower 100 may be coupled to the frame 102 to position them relative to the frame 102 and other components of the mower 100.

In some embodiments, the power system 104 includes a motor 120. The motor 120 may supply motive power used to operate the mower 100. In some embodiments, the motor 120 includes an engine, such as an internal combustion engine (e.g., a gas-fueled engine, a diesel-fueled engine, or a natural gas-fueled engine), an electric motor (e.g., a battery driven electric motor), or a combination thereof (e.g., a hybrid motor). In some embodiments, the motor 120 is coupled to the frame 102. For example, the motor 120 may be bolted, or otherwise secured, to the frame weldment 112. In some embodiments, the power supplied by the motor 120 rotates (or “drives”) a drive shaft of the motor 120, which can, in turn, be used as motive power for other components of the mower 100. For example, rotation of the drive shaft may drive circulation of drive belts that transmit motive power from the drive shaft to the drive system 108 (e.g., to drive rotation of rear wheels) and the cutting system 110 (e.g., to drive rotation of cutting blades).

In some embodiments, one or more drive pulleys are coupled to the drive shaft of the motor 120. The drive pulleys may include, for example, a pump drive pulley and a deck drive pulley. In some embodiments, the drive pulleys engage with respective drive belts that are employed to transmit motive power to other components of the mower 100. For example, the pump drive pulley may engage with a pump drive belt (or “pump belt”) that is circulated to transmit motive power to hydraulic pumps of the drive system 108 (e.g., to drive rotation of rear wheels). The deck drive pulley may engage with a deck drive belt (or “deck belt”) that is circulated to transmit motive power to spindles and cutting blades of the cutting system 110 (e.g., to drive rotation of cutting blades). During operation of the mower 100, the motor 120 may be operated to rotate the drive shaft, the pump drive pulley and the deck drive pulley, which, in turn, drives circulation of the pump drive belt and the deck drive belt.

In some embodiments, the control system 106 includes controls for regulating operation of the mower 100. For example, the control system 106 may include an ignition switch (e.g., a switch operable to start or stop operation of the motor 120), a throttle control (e.g., a lever operable to regulate the operational speed of the motor 120), a blade control (e.g., a knob operable to engage or disengage the cutting system 110), a wheel brake control (e.g., a lever operable to engage or disengage a wheel brake), a deck height control (e.g., a lever to adjust a height of a cutting deck and blades), or a user interface (e.g., a display of status information for the mower 100, such as motor hours, throttle level, fuel level, system warnings, or the like). An operator may interact with the control system 106 to, for example, control and monitor various aspects of the operation of the mower 100.

For reference, the right and left sides of the mower 100 may be defined relative to the direction an operator is expected to be primarily facing while operating the mower 100. “Forward” may refer to the direction that an operator is expected to be primarily facing while operating the mower 100. In accordance with the coordinate system axes illustrated, “right” may refer to the positive “x” direction, “left” may refer to the negative “x” direction, “front” (or “forward”) may refer to the positive “y” direction, “back” (or “rearward” or “backward”) may refer to the negative “y” direction, “up” (or “upward”) may refer to the positive “z” direction, and “down” (or “downward”) may refer to the negative “z” direction. A longitudinal axis 157 of the mower 100 may be oriented in the “y” direction, for example, passing through or near a midpoint between the rear wheels 156 of the mower 100 and extending forward and backward. Unless otherwise specified, “lateral” (or “sideways”) movement of components may refer to the components moving left or right (e.g., moving in a direction parallel to the x-axis), “longitudinal” movement of components may refer to the components moving forward or backwards (e.g., moving in a direction parallel to the y-axis), and “vertical” movement of components may refer to the components moving upwards or downwards (e.g., moving in a direction parallel to the z-axis).

In some embodiments, the drive system (or “propulsion system”) 108 includes components for driving (or “propelling”) the mower 100. In some embodiments, the drive system 108 includes wheel assemblies (or “wheels”) 150 and one or more drive units that supply motive power to propel the mower 100. For example, the drive system 108 may include right and left forward wheel assemblies (or “front wheel assemblies” or “front wheels”) 154, right and left rear wheel assemblies (or “back wheel assemblies” or “back wheels”) 156, and right and left drive units operable to drive rotation of the right and left rear wheels 156, respectively, to propel the mower 100 across the ground. Each of the wheels 150 may include, for example, a tire assembly that includes a tire coupled a rim.

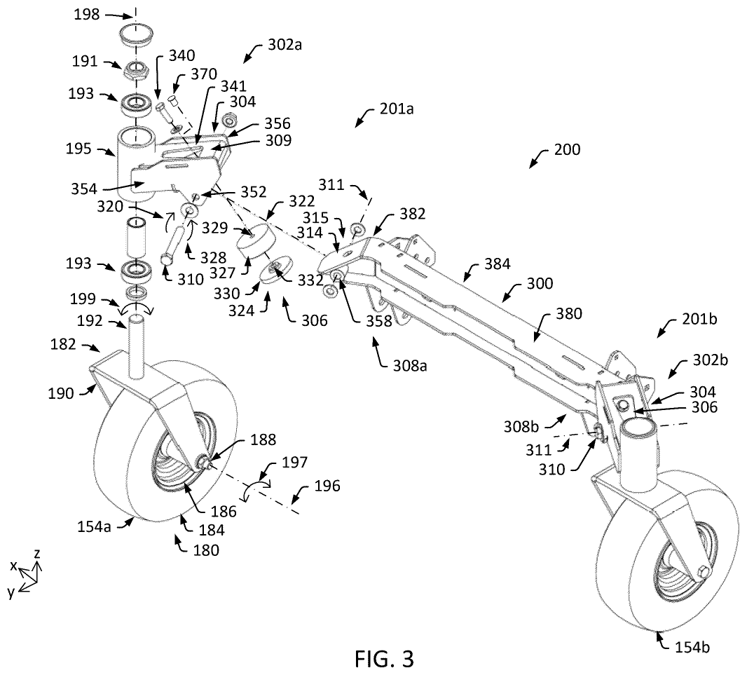

The front wheels 154 may be positioned at or near a front end of the frame system 102. For example, the front wheels 154 may include a right front wheel 154a positioned at a right-front of the mower 100 (e.g., to provide support for a right-front portion of the mower 100) and a left front wheel 154b positioned at a left-front of the mower 100 (e.g., to provide support for a left-front portion of the mower 100). The front wheels 154 may not receive motive power intended to propel the mower 100 and, thus, may be referred to as “non-driven” wheels. In some embodiments, each of the front wheels 154 is a caster style wheel that can swivel about a vertically oriented rotational axis (e.g., a rotational axis oriented in the y-direction) in response to corresponding movements of the mower 100. For example, each of the front wheels 154 may include a tire assembly 180 rotatably coupled to a front caster wheel fork member (“front fork”) 182 that is rotatably coupled to a front portion of the frame 102 of the mower 100. The tire assembly 180 may include a tire 184 (e.g., a rubber tire) mounted to a rim 186 (e.g., a circular metal wheel). The tire assembly 180 may be rotatably coupled to the front fork 182 by way of a wheel axle 188 (e.g., a horizontally oriented rod member, such as a bolt) that passes through the rim 186 and is secured to a body 190 of the fork 182 (e.g., by way of a retainer, such as nut or similar fastener). The front fork 182 may be rotatably coupled to the frame 102, for example, by way of a caster stem 192 that is coupled to a caster receiver 195 located on forward portion of the frame 102. The caster stem 192 may include, for example, a cylindrical member that extends upward from the body 190 of the fork 182. A caster receiver 195 may include, for example, a vertically oriented hollow cylindrical tube (e.g., pivotably coupled to the frame weldment 112 by way of the suspension system 200) having bearings (see, e.g., bearings 193 of FIG. 3) disposed therein. In such an embodiment, the cylindrical member of the caster stem 192 may be disposed through the bearings and the tube of the caster receiver 195 and be secured to the caster receiver 195 by way of a nut (or similar fastener) (see, e.g., fastener 191 of FIG. 3) attached to an upper threaded portion of the cylindrical member of the caster stem 192. During operation, the tire assembly 180 may be free to rotate (or “roll”) about a horizontally oriented axle axis 196 (e.g., a rotational axis defined by a longitudinal axis of the wheel axle 188) (as illustrated by arrow 197), and the front fork 182 and the tire assembly 180 may be free to rotate (or “swivel”) together about a vertically oriented caster axis 198 (e.g., a rotational axis defined by a longitudinal axis of the caster stem 192) (as illustrated by arrow 199). The freedom of movement may enable the tire assembly 180 to roll and swivel in response to corresponding movements of the front portion of the mower 100.

The rear wheels 156 may be positioned at or near a rear end of the frame system 102. For example, the rear wheels 156 may include a right rear wheel 156a positioned at a right-rear of the mower 100 (e.g., to provide support for a right-rear portion of the mower 100) and a left rear wheel 156b positioned at a left-rear of the mower 100 (e.g., to provide support for a left-rear portion of the mower 100). The rear wheels 156 may be driven into rotation by motive power intended to propel the mower 100 and, thus, may be referred to as “driven” or “drive” wheels. In some embodiments, drive units drive rotation of the rear wheels 156 to propel the mower 100. Each of the right and left rear wheels 156a and 156b may be coupled to a drive axle of right and left drive units, respectively. Each of the drive units may include, for example, a hydrostatic (or “hydraulic”) transaxle that is selectively operable to rotate its drive axle (and its associated wheel 156a or 156b) forward or backward about a horizontally oriented rotational axis (e.g., a rotational axis oriented in the x-direction). An operator may, for example, push/pull right or left control levers 158 (which may be coupled to the drive units) to selectively operate the respective drive units to drive rotation of the respective ones of the rear wheels 156a and 156b forward or backward about their rotational axis.

In some embodiments, the cutting system 110 includes components that provide for cutting (or “mowing”) grass. The cutting system 110 may include, for example, a mowing deck system (or “deck system”) 170 that includes a mowing deck (or “deck”) 172 that houses one or more cutting blades (or “blades”) 174. During operation of the mower 100, the blades 174 may be driven into rotation to cut (or “mow”) grass under the deck 172 as the mower 100 traverses the ground. The deck 172 may include, for example, a rigid housing (e.g., a metal housing) that shields the operator and components of the mower 100 from debris, such as flying grass, dust or rocks generated by the rotating blades 174. In some embodiments, the cutting system 110 includes multiple blades 174. For example, the deck system 170 may include left, center, and right blades 174, as illustrated. Each blade 174 may be coupled to a respective spindle system having a pulley and be driven into rotation by circulation of a deck drive belt that engages the pulley.

In some embodiments, the suspension system 200 is operable to dampen jarring and vibrations of the mower 100. For example, the suspension system 200 may regulate movement of the front wheels 154 relative to the frame 102 and other components of the mower 100, which may, in turn, dampen jarring and vibrations associated with movement of, and impacts to, the front wheels 154 of the mower 100. In some embodiments, the suspension system 200 includes a right wheel suspension system 201a and a left wheel suspension system 201b. The right and left wheel suspension systems 201a and 201b may be independent in that they are operable to regulate movement of respective ones of the right and left front wheels 154a and 154b of the mower 100 independent of the other. For example, each of the right and left wheel suspension systems 201a and 201b may provide for “upward” and “rearward” movement of the respective right or left front wheel 154a or 154b relative to other components of the frame 102 and mower 100, which may dampen jarring and vibrations associated with the right or left front wheel 154a or 154b. This may include, for example, jarring and vibrations that may otherwise occur when one of the front wheels 154 impacts an impediment, such as a rock or bump, as the mower 100 traverses terrain. In some embodiments, the right and left wheel suspension systems 201a and 201b include the same or similar arrangements of components. For example, the right and left wheel suspension systems 201a and 201b may be “mirror images” of one another (e.g., mirrored horizontally across the longitudinal axis 157 of the mower 100). Accordingly, although certain embodiments are described with regard to one of the right or left wheel suspension systems 201a or 201b for the purpose of illustration, the other of the right or left wheel suspension systems 201a or 201b may have the same or similar features.

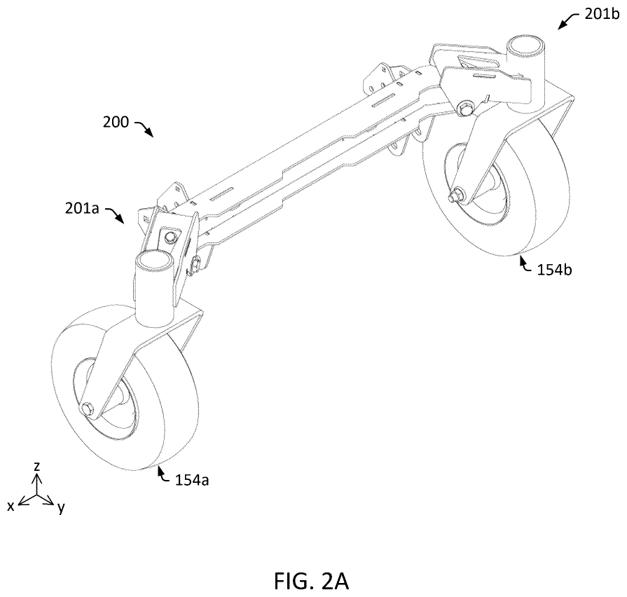

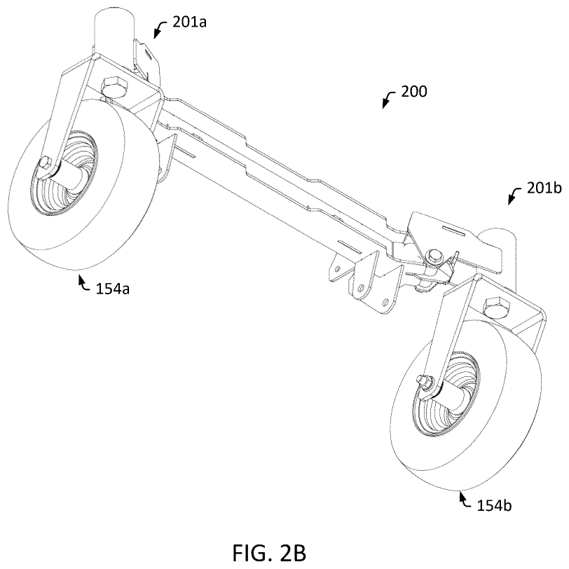

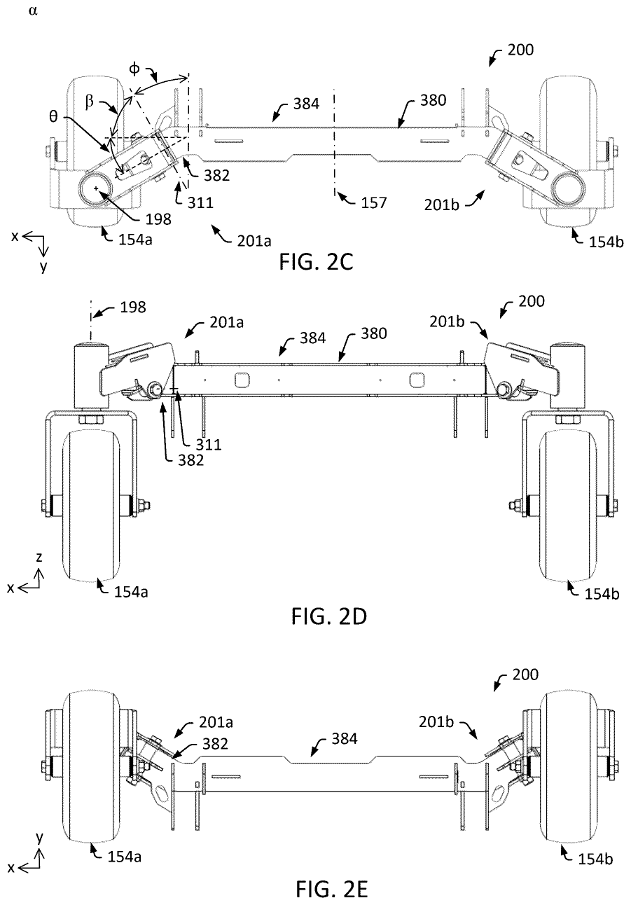

FIGS. 2A-2E illustrate a front-right-top-perspective view, a front-right-bottom-perspective view, a top view, a front view, and a bottom view, respectively, of the front suspension system 200 in accordance with one or more embodiments.

FIG. 3 illustrates an exploded view of a portion of the front suspension system 200 (including an exploded view of the right wheel suspension systems 201a) in accordance with one or more embodiments. Although the left wheel suspension systems 201a is illustrated in an assembled state, the left wheel suspension systems 201a may be a “mirror” image of the right wheel suspension systems 201a, having the same or similar components and arrangement.

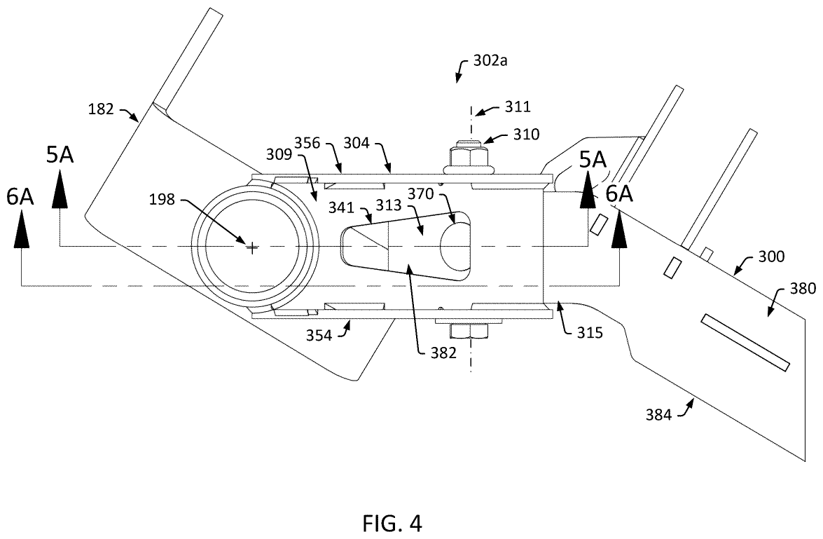

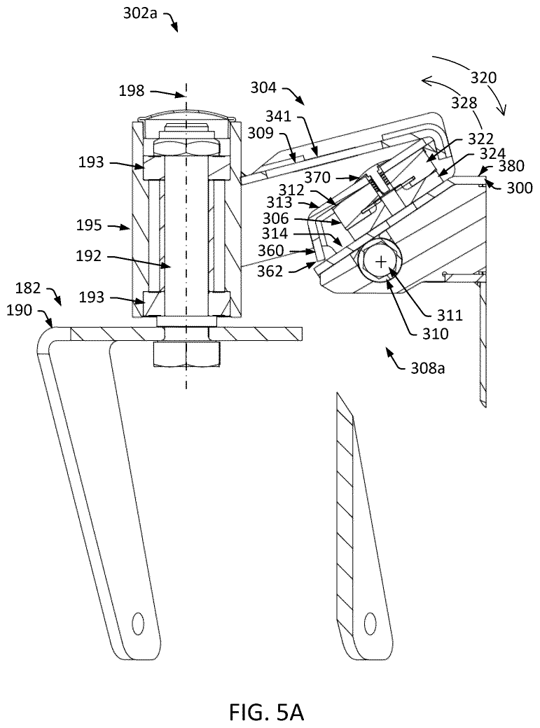

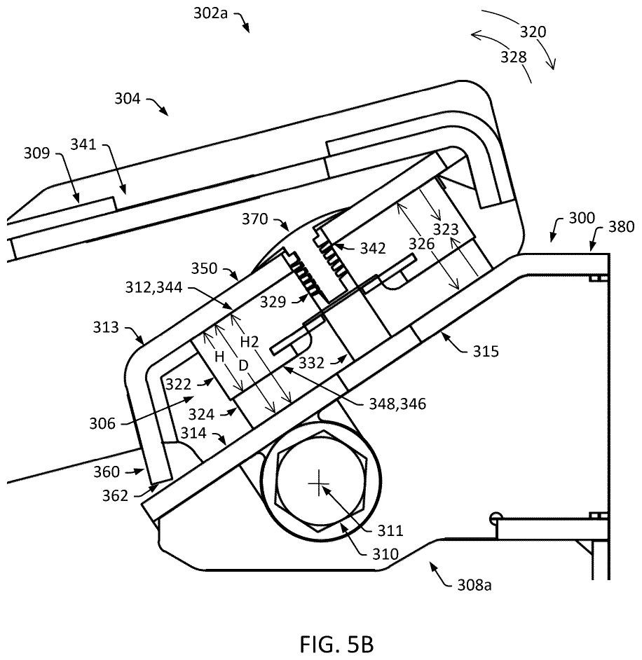

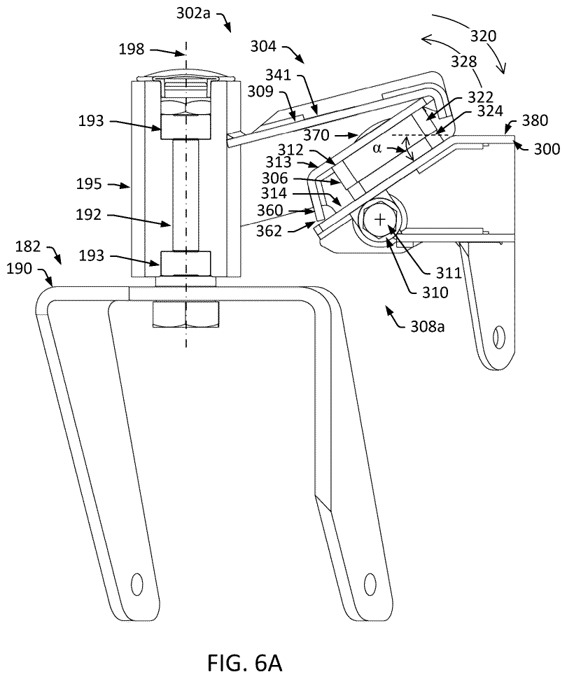

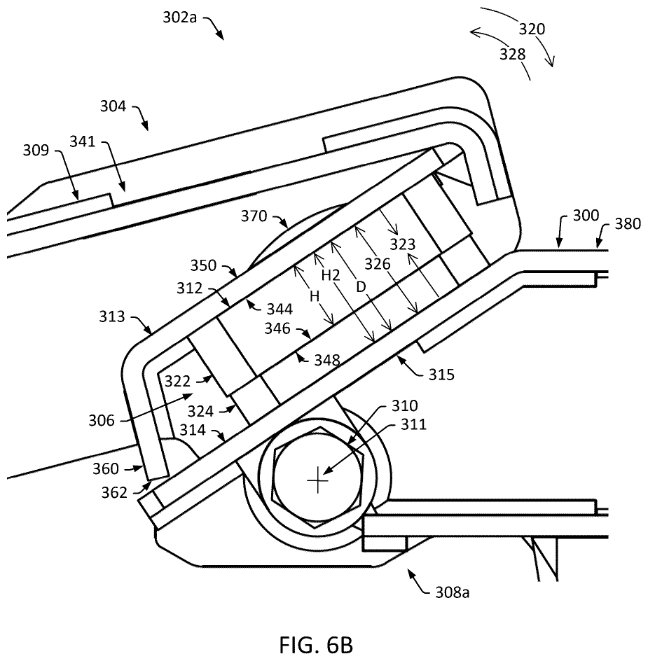

FIG. 4 illustrates a top view of a right portion of the front suspension system 200 (including the right wheel suspension systems 201a) (having a cross-section lines 5A-5A and 6A-6A) in accordance with one or more embodiments. FIG. 5A illustrates a sectioned view of the right portion of the front suspension system 200 (across cross-section line 5A-5A of FIG. 4) in accordance with one or more embodiments. FIG. 5B is a detailed view of a portion of the sectioned view of FIG. 5A. FIG. 6A illustrates a sectioned view of the right portion of the front suspension system 200 (across cross-section line 6A-6A of FIG. 4) in accordance with one or more embodiments. FIG. 6B is a detailed view of a portion of the sectioned view of FIG. 6A.

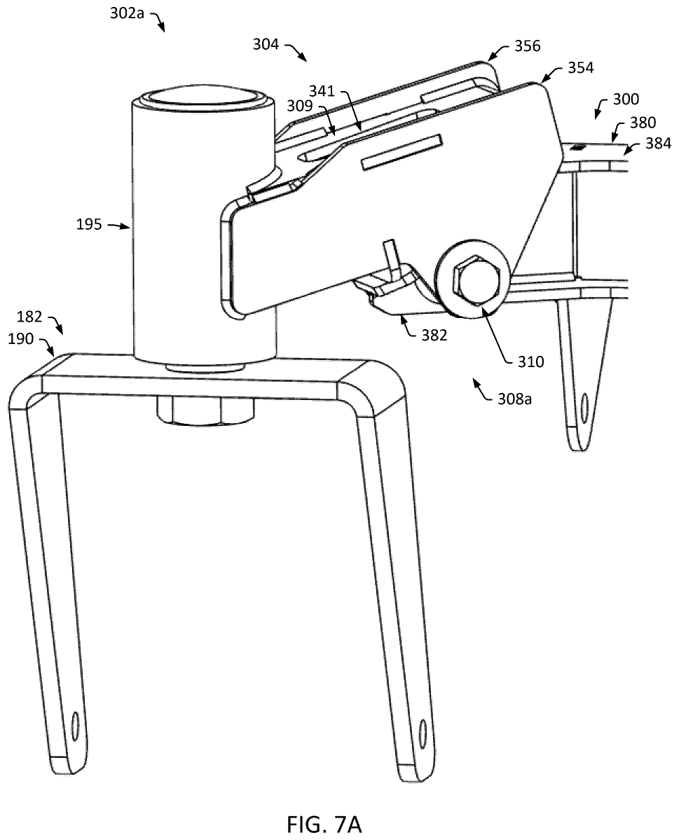

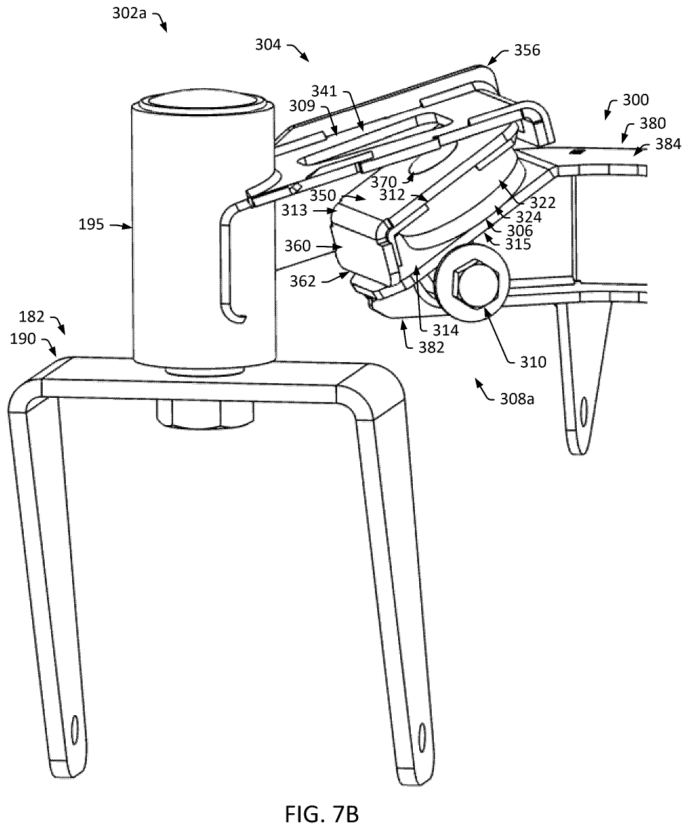

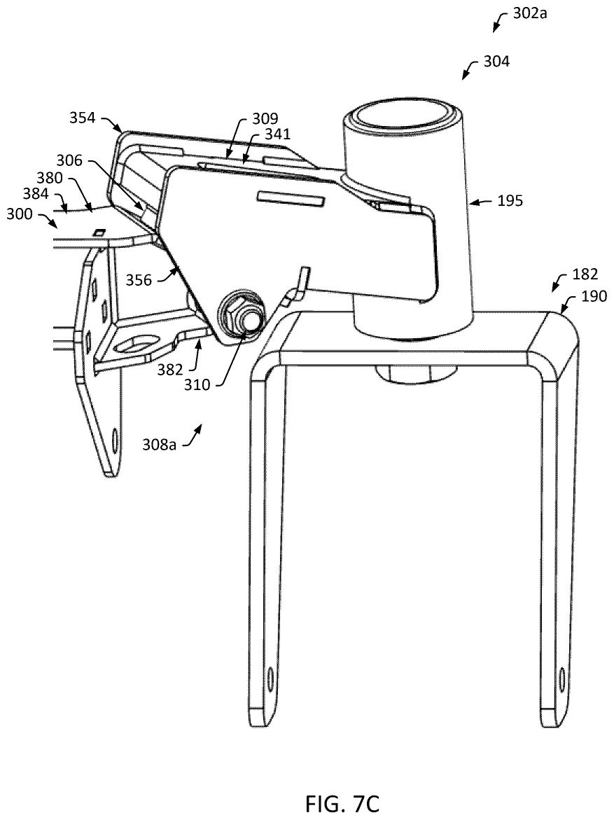

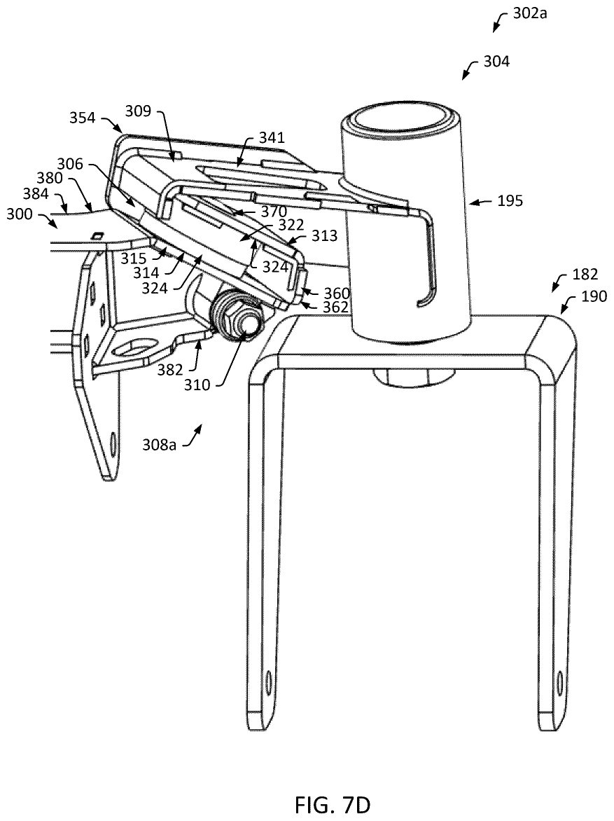

FIGS. 7A-7D illustrate various isometric views of the right portion of the front suspension system 200 (including the right wheel suspension systems 201a) in accordance with one or more embodiments. FIG. 7A illustrates a front view of the right portion of the front suspension system 200, and FIG. 7B illustrates a view similar to that of FIG. 7A, with a front side plate 354 removed from view to enable viewing of certain internal components of the right portion of the front suspension system 200 (including those of the right wheel suspension systems 201a). FIG. 7C illustrates a back view of the right portion of the front suspension system 200, and FIG. 7D illustrates a view similar to that of FIG. 7C, with a back side plate 356 removed from view to enable viewing of certain internal components of the right portion of the front suspension system 200 (including those of the right wheel suspension systems 201a).

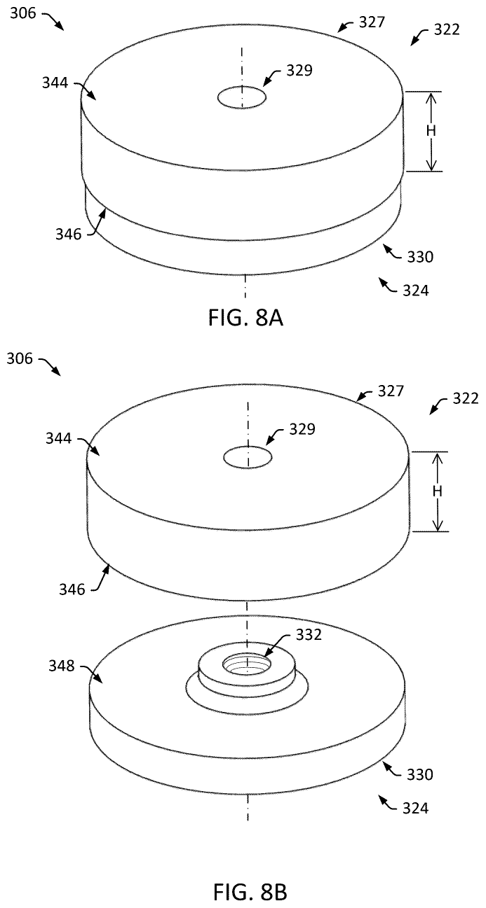

FIGS. 8A and 8B illustrate assembled and exploded views, respectively, of the resilient member assembly 306 in accordance with one or more embodiments.

Referring to FIG. 3, in the illustrated embodiment, the illustrated suspension system 200 includes a crossmember 300 and respective right and left pivoting wheel assemblies 302a and 302b. Each of the pivoting wheel assemblies 302a and 302b may include a respective wheel arm 304 and resilient member assembly 306. Each of the pivoting wheel assemblies 302a and 302b may be coupled to respective right and left ends 308a and 308b of the crossmember 300 by way of a respective pivot 310 (e.g., a bolt). For each of the right and left pivoting wheel assemblies 302a and 302b, the respective resilient member assembly 306 may be disposed between a supporting surface 312 of a retaining plate 313 the wheel arm 304 and a reaction surface 314 of an endplate 315 of the associated end of the crossmember 300 (see, e.g., FIGS. 5A-6B, 7A and 7D). During use, pivoting of the pivoting wheel assemblies 302a and 302b about a respective pivot axis 311 defined by the respective pivots 310 may cause compression of the respective resilient member assembly 306 between the supporting surface 312 and the reaction surface 314, generating a restorative force that encourages the pivoting wheel assemblies 302a and 302b about the pivot axis 311 (and pivot 310) in an opposite direction. For example, referring to FIGS. 3 and 5A-6B, upward force applied to, and resulting upward movement of the right front wheel (e.g., from hitting a bump), may cause a force and torque (in the direction of arrow 320) that causes pivoting of the pivoting wheel assemblies 302a about the pivot 310 (in the direction of arrow 320) that causes compression of a resilient member assembly 306 (located between the supporting surface 312 of the wheel arm 304 and a reaction surface 314 of the associated end of the crossmember 300) (as illustrated by arrows 323 of FIGS. 5B and 6B), and, in turn, the compression of the resilient member 322 may generate a restoring force (illustrated by arrow 326 of FIGS. 5B and 6B) that operates to generate a restoring force on the supporting surface 312 of the wheel arm 304 that generates an associated restoring force and torque (in the direction of arrow 328) that encourages pivoting of the pivoting wheel assemblies 302a about the pivot 310 in the opposite direction (in the direction of arrow 328 of FIGS. 3 and 5A-6B about pivot axis 311). Providing such restorative resistance to pivoting of the pivoting wheel assembly 302a may provide for dampening movement of the front wheels 154 relative to other portions of the mower system 100. In some embodiments, the pivot axis 311 is transverse to the caster axis 198. For example, as illustrated, the caster axis 198 may be oriented in a generally vertical orientation, with the pivot axis 311 oriented in a generally horizontal orientation and offset from the caster axis 198. In some embodiments, the pivot axis 311 is angled relative to the longitudinal axis 157 of the mower 100. For example, as illustrated, referring to FIG. 2C, the pivot axis 311 may be generally horizontal at an angle (ϕ) (e.g., in the range of about 25-35 degrees, e.g., 30 degrees or about) relative to the longitudinal axis 157 of the mower 100. Notably, in the illustrated embodiment, angle (ϕ) may be equal to angle (θ). In such an embodiment, the pivot axis 311 may be generally horizontal at an angle (β) (e.g., β=90−ϕ or β=90−θ) (e.g., in the range of about 55-65 degrees, e.g., 60 degrees or about) relative to a longitudinal axis of the crossmember 300. In some embodiments, the pivot axis 311 is transverse to a longitudinal axis of a portion of the crossmember 300 through which it passes.

Referring to FIGS. 3 and 5A-8B, which provide various views and details of the illustrated suspension system 200, including exploded and detailed views of the right wheel suspension systems 201a and resilient member assembly 306, in some embodiments, resilient member assembly 306 includes a resilient member 322 and a retaining member 324. As described, the resilient member 322 may include a relatively deformable member (e.g., a cylindrical member formed of rubber or another elastomer or relatively soft/deformable material, such as styrene-butadiene rubber (SBR), for example, having a 60A Durometer or the like) and the retaining member 324 may include a relatively rigid member (e.g., a cylindrical member formed of metal or another metal or relatively rigid/non-deformable material, such as steel) that can be employed to retain and compress the resilient member 322. Referring to FIGS. 8A and 8B, the resilient member 322 may include a disc-shaped body 327 having a hole 329 extending therethrough (e.g., a smooth through hole defining a donut shaped body), and the retaining member 324 may include a disc-shaped body 330 having a threaded hole 332 extending therethrough (e.g., a threaded through hole defining a donut shaped body). During an assembly process, a bolt (“preload bolt”) 340 (see, e.g., FIG. 4) may be passed through an opening 341 in a top plate 309 of the wheel arm 304 and a hole 342 in the retaining plate 313 of the wheel arm 304 (which defines the supporting surface 312 of the wheel arm 304) and into hole 329 of the resilient member 322 (e.g., with a top side 344 of the body 327 of the resilient member 322 adjacent the supporting surface 312 and a bottom side 346 of the body 327 of the resilient member 322 adjacent a top side 348 of the body 330 of the retaining member 324), and a distal-threaded end of the bolt 340 that is passed through the hole 342 of the retaining plate 313 and the hole 329 of the resilient member 322 may be threaded into the threaded hole 332 of the retaining member 324. As the bolt 340 is threaded into the threaded hole 332 (or “tightened”), a head of the bolt 340 may engage a top side 350 (see, e.g., FIGS. 5B and 6B) of the retaining plate 313, and continued tightening of the bolt 340 may cause the top side 348 of the body 330 of the retaining member 324 to engage the bottom side 346 of the body 327 of the resilient member 322, with further tightening causing the top side 344 of the resilient member 322 to engage the supporting surface (or “bottom side” or “bottom surface”) 312 of the retaining plate 313. This further tightening may, compress (or “squeeze” or “sandwich”) the resilient member 322 between the top side 348 of the body 330 of the retaining member 324 and the bottom side (supporting surface 312) of the retaining plate 313, which may, in turn, cause a reduction the height (H) of the resilient member 322.

The induced compression by way of the bolt 340 may be referred to as “preloading” of the resilient member 322 and may be conducted in an effort to reduce the height (H) of the resilient member 322 to aid installation of the resilient member assembly 306 between the supporting surface 312 of the retaining plate 313 and the reaction surface (or “top side” or “top surface”) 314 of the endplate 315. For example, referring to FIG. 3, with the resilient member 322 preloaded as described, holes 352 extending through front and back side plates 354 and 356, respectively, of wheel arm 304 may be aligned with a corresponding hole 358 of right end 308a of crossmember 300. With the holes 352 and 358 aligned, the pivot (e.g., a bolt) 310 may be inserted through the aligned holes 352 and 358, and be secured with a fastener (e.g., a nut) to pivotably couple wheel arm 304 and other components of right pivot wheel assembly 302a to the right end 308a of crossmember 300. Subsequent to such assembly, the bolt (or “preload bolt”) 340 may be removed to allow for decompression/expansion of the resilient member 322 between the top side 348 of the body 330 of the retaining member 324 and the bottom side (supporting surface 312) of the retaining plate 313, which may, in turn provide an increase in the height (H) of the resilient member 322 and the overall height (H2) of the resilient member assembly 306, or at least an increase in the forces acting against the top side 348 of the body 330 of the retaining member 324 and the bottom side (supporting surface 312) of the retaining plate 313, due to decompression/expansion of the resilient member 322. This may generate a torque (in the direction of arrow 328) that causes or otherwise encourages pivoting of the pivoting wheel assembly 302a about the pivot 310 in the same direction (in the direction of arrow 328). In some embodiments, a distal end (or “wing”) 360 of the retaining plate 313 acts to limit rotational movement of the pivoting wheel assembly 302a. For example, the distal end (or “wing”) 360 of the retaining plate 313 may extend downward toward the reaction surface (or “top side” or “top surface”) 314 of the endplate 315 (e.g., at a downward angle (e.g., about 70 degrees) relative to the retaining plate 313) and have an end (or “nose”) 362 that is disposed proximate to the reaction surface (or “top side” or “top surface”) 314 of the endplate 315. Extended rotation of the pivoting wheel assembly 302a (e.g., in the direction of arrow 328 due to decompression/expansion of the resilient member 322) may cause the end 362 to engage the reaction surface (or “top side” or “top surface”) 314 of the endplate 315, which can, in turn, limit (or otherwise inhibit) further rotation of the pivoting wheel assembly 302a about pivot 310 (e.g., limit further rotation in the direction of arrow 328). Rotation of the pivoting wheel assembly 302a about pivot 310 (e.g., in the direction of arrow 320) may, for example, be limited by forces caused by compression of the resilient member assembly 306.

If, for example, the resilient member 322 is not preloaded to reduce its height (H), the resilient member assembly 306 may have a height (H2) that is greater than the desired distance (D) between the bottom side (supporting surface 312) of the retaining plate 313 and the reaction surface (or “top side” or “top surface”) 314 of the endplate 315. As a result, assembly of pivoting wheel assembly 302a to the right end 308a of the crossmember 300 may require at least partial compression of the resilient member assembly 306 (e.g., by an assembler) to provide for alignment of the holes 352 and 358 and the insertion of pivot 310 (e.g., a bolt) therethrough. Thus, such preloading of the resilient member 322 may help to enable and simplify assembly of the pivoting wheel assembly 302a to the right end 308a of the crossmember 300.

In some embodiments, a plug 370 is inserted in place of the bolt 340. For example, bolt 340 may be unthreaded from threaded hole 332, and be removed from the resilient member assembly 306 through the opening 341 in the top plate 309 of the wheel arm 304, and the plug 370 may then be passed through the opening 341 in the top plate 309 of the wheel arm 304 and be inserted into hole 342 of retaining plate 313 and the hole 329 of the resilient member 322. Such a plug 370 may help to reduce debris or other unwanted items from making its way into the resilient member assembly 306. In the case of disassembly, the above processes may be accomplished in reverse to aid in the removal of pivot 310 and the removal of the pivoting wheel assembly 302a from the right end 308a of the crossmember 300. For example, the plug 370 may be removed, the bolt 340 may be inserted and tightened to preload the resilient member assembly 306, and the pivot 310 may be removed to release the pivoting wheel assembly 302a from the right end 308a of the crossmember 300.

In some embodiments, the reaction surface 314 of the associated end of the crossmember 300 is angled. For example, referencing FIGS. 5A and 6A, in the illustrated embodiment, the reaction surface 314 includes a planar surface at the right end 308a of the crossmember 300, angled forward and downward relative to horizontal. The reaction surface 314 may, for example, be oriented downward at an angle (α) relative to a generally horizontal top surface 380 of the crossmember 300. Referencing FIGS. 5B and 6B, the retaining plate 313 and the supporting surface 312 of the retaining plate 313 may be oriented generally parallel to the downward angled reaction surface 314. For example, the resilient member assembly 306 may be sized to have an overall un-compressed height (H2) that is greater the distance (D) between the supporting surface 312 and reaction surface 314 when the end (or “nose”) 362 is disposed proximate to the reaction surface 314 of the endplate 315, and compressed height (H2) that is equal to the distance (D) between the supporting surface 312 and reaction surface 314 when the end (or “nose”) 362 is rotated proximate to the reaction surface 314 of the endplate 315. In such an embodiment, the resilient member assembly 306 may be sandwiched between generally parallel reaction and supporting surfaces, which can provide for relatively even distribution of compressive forces (e.g., in the direction of arrows 326) against the reaction and supporting surfaces, and relatively even distribution of compressive forces across the body 327 and surfaces 344 and 346 of the resilient member 322, which may aid in reducing uneven wear of the resilient member 322 and the reaction and supporting surfaces.

In some embodiments, the reaction surface 314 of the associated end of the crossmember 300 is angled relative to horizontal. For example, referencing FIGS. 3 and 5A-6B, in the illustrated embodiment, the reaction surface 314 includes a planar surface disposed at the right end 308a of the crossmember 300, that is angled relative to horizontal. Referencing FIG. 6B, the reaction surface 314 may, for example, be oriented downward at an angle (α) (e.g., in the range of about 30-40 degrees, e.g., 35 degrees or about) relative to a generally horizontally oriented top surface 380 of the crossmember 300. The angled end of the crossmember 300 (and associated positioning of the resilient member assembly 306 on to thereof) may provide a relatively compact and low profile suspension package by, for example, by allowing the resilient member assembly 306 to sit at least partially below a level of the top surface 380 of the crossmember 300.

In some embodiments, the reaction surface 314 of the associated end of the crossmember 300 is angled forward. For example, referencing FIG. 2C, in the illustrated embodiment, the reaction surface 314 includes a planar surface disposed at an end portion 382 of the crossmember 300 that is angled forward relative to a central portion 384 of the crossmember 300. For example, end portion 382 may extend forward at an angle (θ) (e.g., in the range of about 25-35 degrees, e.g., 30 degrees or about) relative to a generally laterally oriented central portion 384 of the crossmember 300. Such partially forward and lateral orientation of the reaction surface 314 (and associated positioning of the resilient member assembly 306) may enhance the ability to absorb impacts and loads, which can often occur with some force component aligned with the angle of the end portion 382 (e.g., as the mower 100 moves forward or is turned sideways).

What is claimed is:

1. A zero-turn-radius (ZTR) riding mower system, comprising:
a right front caster wheel;
a left front caster wheel;
a right rear drive wheel configured to be selectively driven into rotation by a right drive unit;
a left rear drive wheel configured to be selectively driven into rotation by a left drive unit;
a frame system comprising:
a frame weldment; and
a front wheel suspension system comprising:
a right front wheel suspension system configured to provide for regulated movement of the right front caster wheel relative to the frame weldment, the right front wheel suspension system comprising:
a right pivoting wheel assembly comprising:
a right wheel arm pivotably coupled to a crossmember of the frame weldment by way of a right pivot and the right wheel arm configured to pivot about a right pivot axis defined by the right pivot, the right front caster wheel coupled to the right wheel arm; and
a right resilient member assembly disposed between the right wheel arm and the crossmember, the right resilient member assembly configured to be compressed between the right wheel arm and the crossmember to dampen pivoting of the right wheel arm and the right front caster wheel about the right pivot axis; and
a left pivoting wheel assembly comprising:
a left wheel arm pivotably coupled to the crossmember of the frame weldment by way of a left pivot and the left wheel arm configured to pivot about a left pivot axis defined by the left pivot, the left front caster wheel coupled to the left wheel arm; and
a left resilient member assembly disposed between the left wheel arm and the crossmember, the left resilient member assembly configured to be compressed between the left wheel arm and the crossmember to dampen pivoting of the left wheel arm and the left front caster wheel about the left pivot axis.

2. The system of claim 1, wherein:
the right resilient member assembly is configured to be compressed to dampen upward movement of the right wheel arm and the right front caster wheel relative to the crossmember, and
the left resilient member assembly is configured to be compressed to dampen upward movement of the left wheel arm and the left front caster wheel relative to the crossmember.

3. The system of claim 1, wherein:
the right wheel arm comprises a retaining plate comprising a planar surface,
a right end of the crossmember comprises a planar surface, and
the right resilient member assembly is configured to be compressed between the planar surface of the right retaining plate and the planar surface of the right end of the crossmember to dampen the pivoting of the right wheel arm and the right front caster wheel about the right pivot axis, and
the left wheel arm comprises a left retaining plate comprising a planar surface,
a left end of the crossmember comprises a planar surface, and
the left resilient member assembly is configured to be compressed between the planar surface of the left retaining plate and the planar surface of the left end of the crossmember to dampen the pivoting of the right wheel arm and the right front caster wheel about the right pivot axis.

4. The system of claim 1, wherein:
the right resilient member assembly comprises a right resilient member configured to be disposed proximate a surface of the right wheel arm and a right retaining member configured to be disposed adjacent the right resilient member and proximate a right surface of the crossmember, and
the left resilient member assembly comprises a left resilient member configured to be disposed proximate a surface of the left wheel arm and a left retaining member configured to be disposed adjacent the left resilient member and proximate a left surface of the crossmember.

5. The system of claim 1, wherein:
the right front caster wheel is configured to swivel about a right caster axis and the right pivot axis is oriented transverse to the right caster axis, and
the left front caster wheel is configured to swivel about a left caster axis and the left pivot axis is oriented transverse to the left caster axis.

6. A mower system, comprising:
a right front caster wheel;
a left front caster wheel;
a right rear drive wheel configured to be driven into rotation;
a left rear drive wheel configured to be driven into rotation;
a frame system comprising:
a frame weldment; and
a front wheel suspension system comprising:
a right front wheel suspension system configured to provide for regulated movement of the right front caster wheel relative to the frame weldment, the right front wheel suspension system comprising:
a right pivoting wheel assembly comprising:
a right wheel arm configured to be pivotably coupled to a crossmember of the frame weldment by way of a right pivot and the right wheel arm configured to pivot about a right pivot axis defined by the right pivot, the right front caster wheel configured to be coupled to the right wheel arm; and
a right resilient member assembly configured to be disposed between the right wheel arm and the crossmember, the right resilient member assembly configured to be compressed between the right wheel arm and the crossmember to dampen pivoting of the right wheel arm and the right front caster wheel about the right pivot axis; and
a left pivoting wheel assembly comprising:
a left wheel arm configured to be pivotably coupled to the crossmember of the frame weldment by way of a left pivot and the left wheel arm configured to pivot about a left pivot axis defined by the left pivot, the left front caster wheel configured to be coupled to the left wheel arm; and
a left resilient member assembly configured to be disposed between the left wheel arm and the crossmember, the left resilient member assembly configured to be compressed between the left wheel arm and the crossmember to dampen pivoting of the left wheel arm and the left front caster wheel about the left pivot axis.

7. The system of claim 6, wherein:
the right resilient member assembly is configured to be compressed to dampen the pivoting of the right wheel arm and the right front caster wheel about the right pivot axis, and
the left resilient member assembly is configured to be compressed to dampen the pivoting of the left wheel arm and the left front caster wheel about the left pivot axis.

8. The system of claim 6, wherein:
the right wheel arm comprises a planar surface,
a right end of the crossmember comprises a planar surface, and
the right resilient member assembly is configured to be compressed between the planar surface of the right wheel arm and the planar surface of the right end of the crossmember to dampen the pivoting of the right wheel arm and the right front caster wheel about the right pivot axis, and
the left wheel arm comprises a planar surface,
a left end of the crossmember comprises a planar surface, and
the left resilient member assembly is configured to be compressed between the planar surface of the left wheel arm and the planar surface of the left end of the crossmember to dampen the pivoting of the left wheel arm and the left front caster wheel about the left pivot axis.

9. The system of claim 6, wherein:
the right resilient member assembly is configured to be compressed to dampen upward movement of the right wheel arm and the right front caster wheel relative to the crossmember, and
the left resilient member assembly is configured to be compressed to dampen upward movement of the left wheel arm and the left front caster wheel relative to the crossmember.

10. The system of claim 6, wherein:
the right resilient member assembly comprises a right resilient member configured to be disposed proximate a surface of the right wheel arm and a right retaining member configured to be disposed adjacent the right resilient member and proximate a right surface of the crossmember, and
the left resilient member assembly comprises a left resilient member configured to be disposed proximate a surface of the left wheel arm and a left retaining member configured to be disposed adjacent the left resilient member and proximate a left surface of the crossmember.

11. The system of claim 6, wherein:
the right front caster wheel is configured to swivel about a right caster axis and the right pivot axis is configured to be oriented transverse to the right caster axis, and
the left front caster wheel is configured to swivel about a left caster axis and the left pivot axis is configured to be oriented transverse to the left caster axis.

12. The system of claim 6, wherein the mower system comprises a zero-turn-radius (ZTR) riding mower system.

13. A mower system, comprising:
a front wheel suspension system configured to provide for regulated movement of a front caster wheel relative to a frame weldment of the mower system, the front wheel suspension system comprising:
a pivoting wheel assembly comprising:
a wheel arm configured to be pivotably coupled to a crossmember of the frame weldment by way of a pivot and the wheel arm configured to pivot about a pivot axis defined by the pivot, the front caster wheel configured to be coupled to the wheel arm; and
a resilient member assembly configured to be disposed between the wheel arm and the crossmember, the resilient member assembly configured to be compressed between the wheel arm and the crossmember to dampen pivoting of the wheel arm and the front caster wheel about the pivot axis.

14. The system of claim 13, wherein:
the resilient member assembly is configured to be compressed to dampen the pivoting of the wheel arm and the front caster wheel about the pivot axis.

15. The system of claim 13, wherein:
the wheel arm comprises a planar surface,
an end of the crossmember comprises a planar surface, and
the resilient member assembly is configured to be compressed between the planar surface of the wheel arm and the planar surface of the end of the crossmember to dampen the pivoting of the wheel arm and the front caster wheel about the pivot axis.

16. The system of claim 13, wherein:
the resilient member assembly is configured to be compressed to dampen upward movement of the wheel arm and the front caster wheel relative to the crossmember.

17. The system of claim 13, wherein:
the resilient member assembly comprises a resilient member and a retaining member configured to be disposed adjacent the resilient member, and the resilient member is configured to be disposed proximate a surface of the wheel arm and the retaining member is configured to be disposed proximate a surface of the crossmember.

18. The system of claim 13, wherein:
the front caster wheel is configured to swivel about a caster axis and the pivot axis is configured to be oriented transverse to the caster axis.

19. The system of claim 13, wherein the mower system comprises a zero-turn-radius (ZTR) riding mower system.
